(19) United States
(12) Patent Application Publication
(10) Pub. No.: US 2022/0032171 A1
(43) Pub. Date: Feb. 3, 2022

(54) MEANINGFUL COMBINATION GENERATING LOGIC CUBE

(71) Applicant: Harshad Bhavsar, Boston, MA (US)

(72) Inventor: Harshad Bhavsar, Boston, MA (US)

(21) Appl. No.: 16/944,114

(22) Filed: Jul. 30, 2020

(51) Int. Cl. A63F 9/08; A63F 3/04

(52) U.S. Cl. CPC A63F 9/0842; A63F 2003/0418; A63F 2009/0849; A63F 3/0415

(57) ABSTRACT

A logic cube for teaching, learning, entertainment and motivation is presented. The logic cube has indicia arranged in well-defined orientations including radial symmetry, pairing pattern and triple logic. The pairing pattern helps to generate meaningful combinations for applications involving sets of two (2). The triple logic helps to generate meaningful combinations for applications involving sets of three (3). Radial symmetry helps generate meaningful combinations involving a greater number of indicia. Applying the exclusion logic helps to avoid meaningless or undesirable combinations and ambigrams help to include indicia which can be read in multiple orientations. The invention of logic cube provides a new function which can be applied to numerous areas such as science, arts, food, fashion, motivation and general education and it provides a novel experience as compared to prior art. The invention of logic cube could be applied to other geometric shapes such as tetrahedron (Pyraminx®) and dodecahedron (Megaminx®) and sizes other than 3×3×3.

### FIELD OF THE INVENTION

This invention relates to family of logic cubes. More particularly, it relates to using indicia on the faces of logic cube in specific orientations to generate numerous meaningful combinations, thereby providing a new function which can be applied to numerous areas and a novel experience as compared to prior art.

### BACKGROUND

Rubik's Cube is a 3-D combination puzzle invented in 1974 by Hungarian sculptor and professor of architecture Erna Rubik. Originally called the Magic Cube, the puzzle was licensed by Rubik to be sold by Ideal Toy Corp. The Rubik's® Cube won the 1980 German Game of the Year special award for Best Puzzle. As of January 2009, 350 million cubes had been sold worldwide, making it the world's top-selling puzzle game. It is widely considered to be the world's best-selling toy.

On the original classic Rubik's® Cube, each of the six faces was covered by nine stickers, each one of six solid colors: white, red, blue, orange, green, and yellow. Some current versions of the cube have been updated to use colored plastic panels instead, which prevents peeling and fading. In currently sold models, white is opposite yellow, blue is opposite green, and orange is opposite red, and the red, white, and blue are arranged in that order in a clockwise arrangement. On early cubes, the position of the colors varied from cube to cube. An internal pivot mechanism enables each face to turn independently, thus mixing up the colors. For the puzzle to be solved, each face must be returned to have only one color. Similar puzzles have now been produced with various numbers of sides, dimensions, and stickers, not all of hem by Rubik.

Although the Rubik's® Cube reached its height of mainstream popularity in the 1980s, it is still widely known and used. Many speed-cubers continue to practice it and similar puzzles; they also compete for the fastest times in various categories. Since 2003, the World Cube Association, the Rubik's® Cube's international governing body, has organized competitions worldwide and recognizes world records.

Many people are fascinated by the Rubik's® cube. Though some can easily solve the Rubik's® cube given proper learning and memory concepts as well as patience. Most however become frustrated and bored from struggling to conquer the Rubik's® cube they will discard or store the Rubik's® cube causing a waste of time and money.

Accordingly, and in light of the foregoing, there is a need for a logic cube that can provide multiple meaningful combinations which can be applied to learning, entertainment and motivation applying well defined orientations such radial symmetry and pairing patterns.

### BRIEF DESCRIPTION OF THE DRAWINGS

FIG. 1A through FIG. 1D are illustrated views of a prior art logic cube demonstrating the pivotal mechanism with rotation of one layer along X axis in steps of 30°.

FIG. 2A through FIG. 2D are illustrated views of an embodiment of logic cube using indicia in specific orientation of pairing logic, as well as demonstrating the pivotal mechanism with rotation of one layer along X axis in steps of 30°.

FIG. 3A through FIG. 3D are illustrated views of an exemplary logic cube applying pairing logic to indicia, as well as demonstrating the pivotal mechanism with rotation of one layer along X axis in steps of 30°.

FIG. 4A through FIG. 4D are illustrated views of an embodiment of logic cube using indicia in specific orientation of radial symmetry logic, as well as demonstrating the pivotal mechanism with rotation of one layer along X axis in steps of 30°.

FIG. 5A through FIG. 5D are illustrated views of an exemplary logic cube applying radial symmetry logic to indicia, as well as demonstrating the pivotal mechanism with rotation of one layer along X axis in steps of 30°.

FIG. 6A through FIG. 6D are illustrated views of an exemplary logic cube applying three element or triple logic to indicia, as well as demonstrating the pivotal mechanism with rotation of one layer along X axis in steps of 30°.

FIG. 7A through FIG. 7D are illustrated views of an exemplary logic cube applying pairing logic along with ambigrams to indicia, as well as demonstrating the pivotal mechanism with rotation of one layer along X axis in steps of 30°.

FIG. 8A through FIG. 8D are illustrated views of an exemplary logic cube applying a variation of orientation to generate puzzles, as well as demonstrating the pivotal mechanism with rotation of one layer along X axis in steps of 30°.

FIG. 9 and FIG. 10 are illustrated views of embodiment of logic tetrahedron and logic dodecahedron respectively using indicia in specific orientations.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

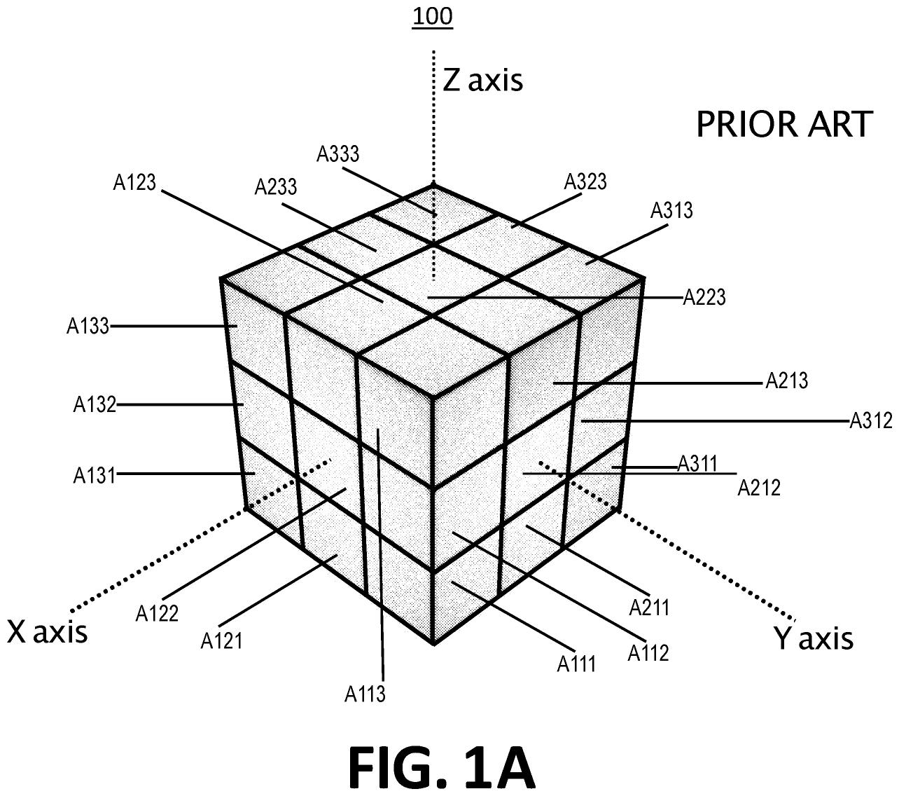

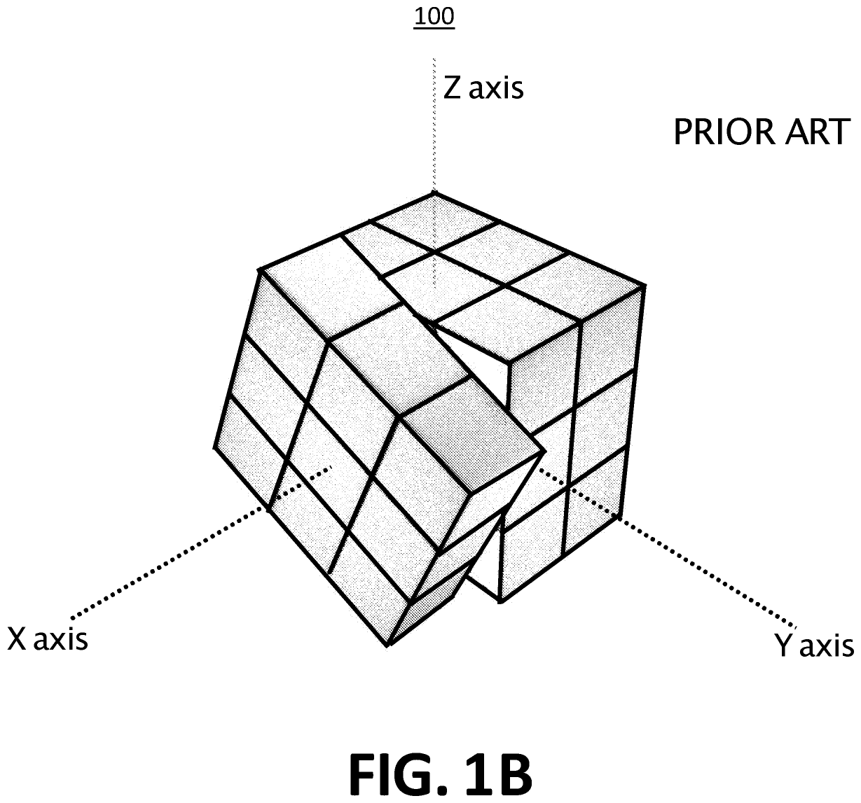

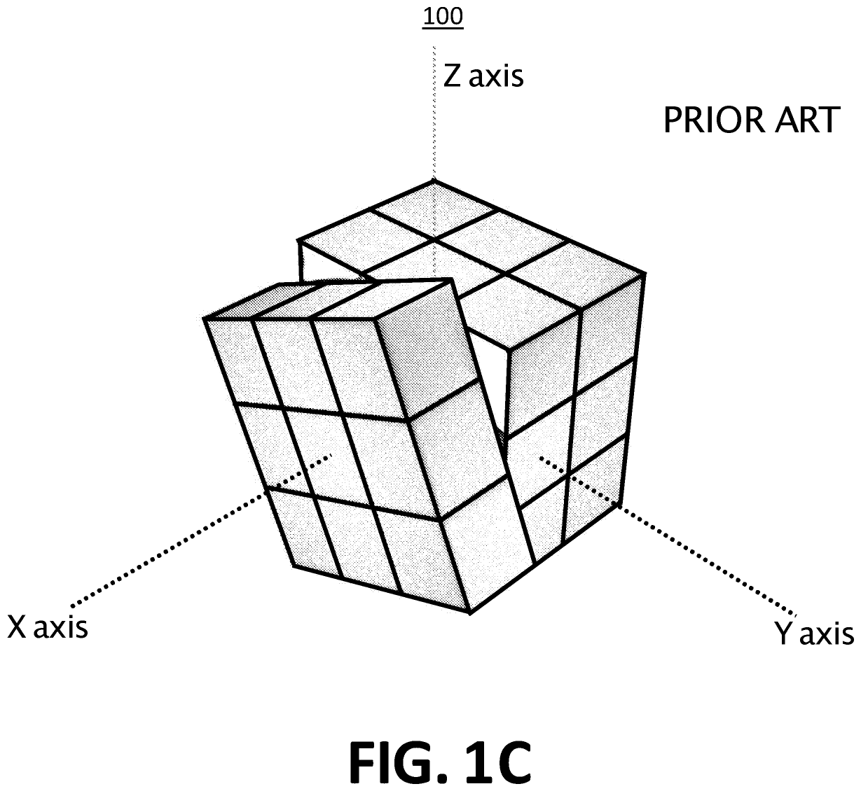

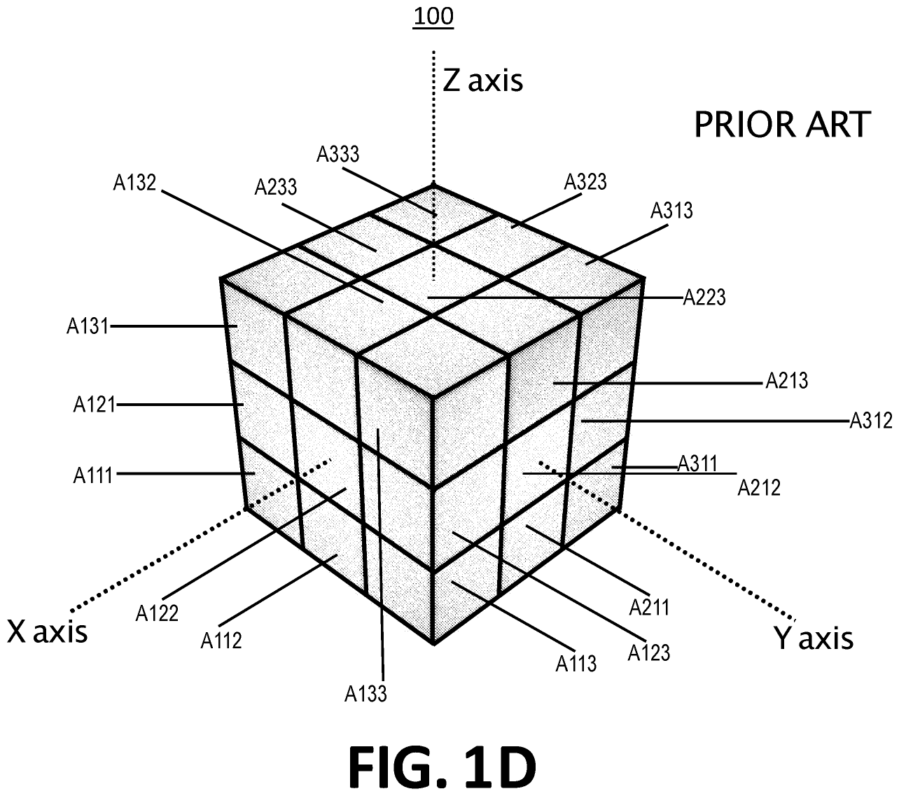

Referring to FIG. 1A through FIG. 1D, a prior art logic cube 100, substantially similar to a Rubik's® cube is presented. The logic cube 100 is typically known as a Rubik's® cube, however other types of logic cubes are hereby contemplated, including, but not limited to, hexagon, tripoidal, etc. The logic cube 100 has three (3) layers across three (3) axes: X, Y and Z thereby representing a 3×3×3 cube, however other sizes of logic puzzles having rotatable layers with different shapes are known in the art, including but not limited to, 2×2×2, 4×4×4, etc.

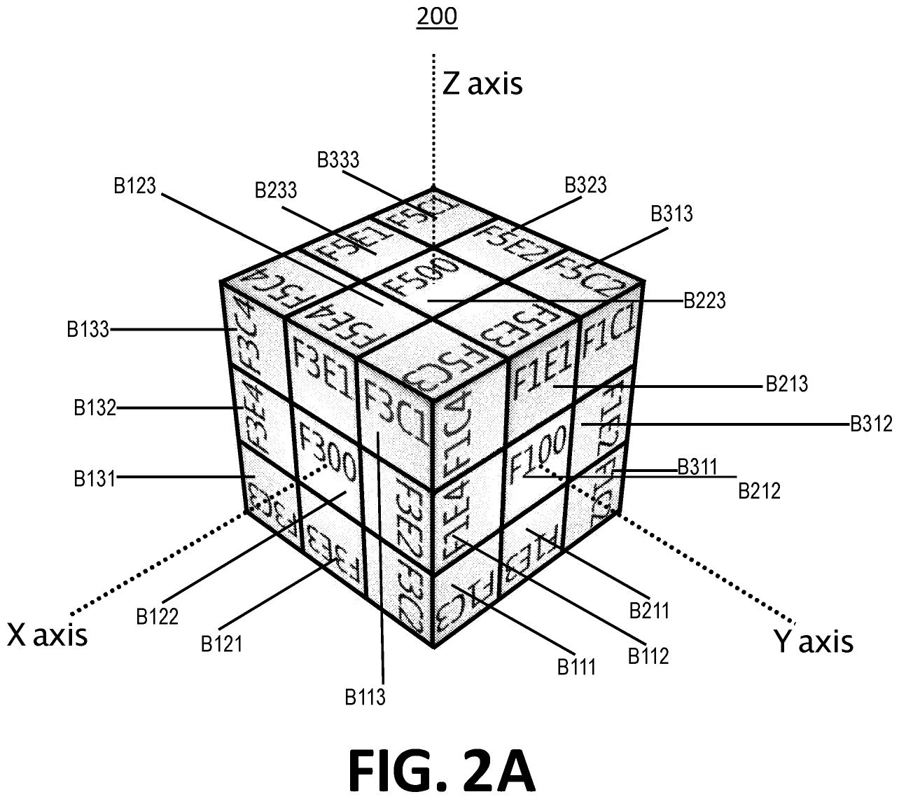

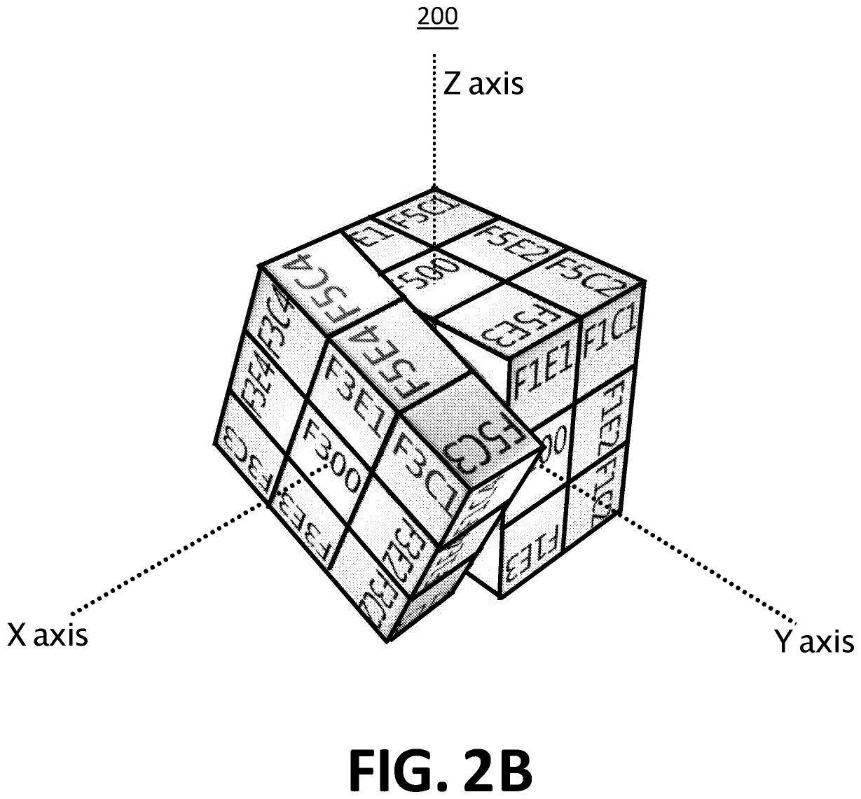

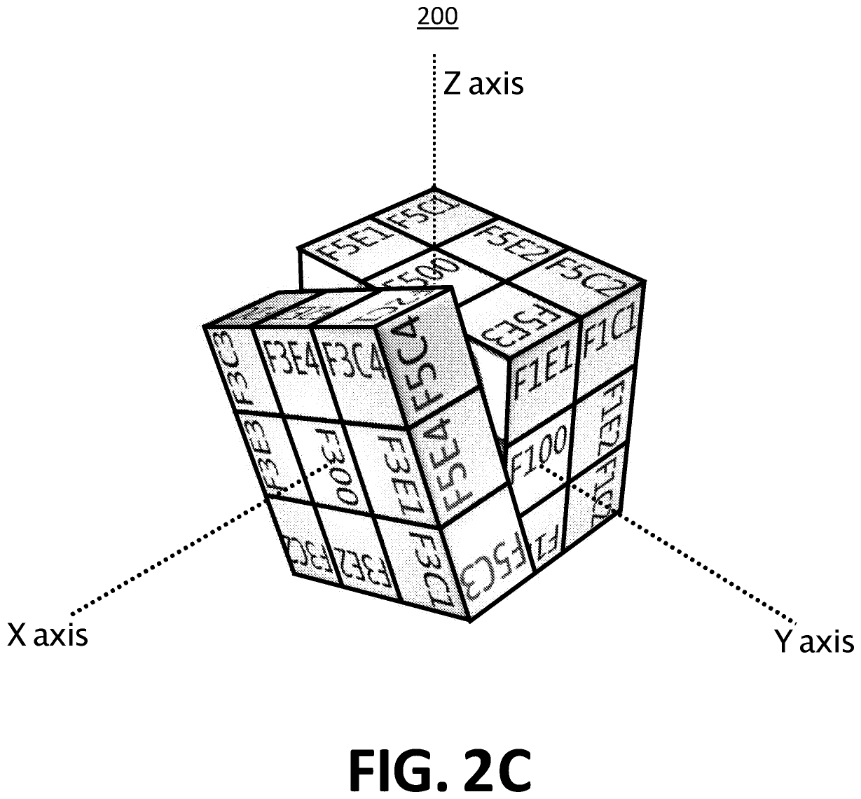

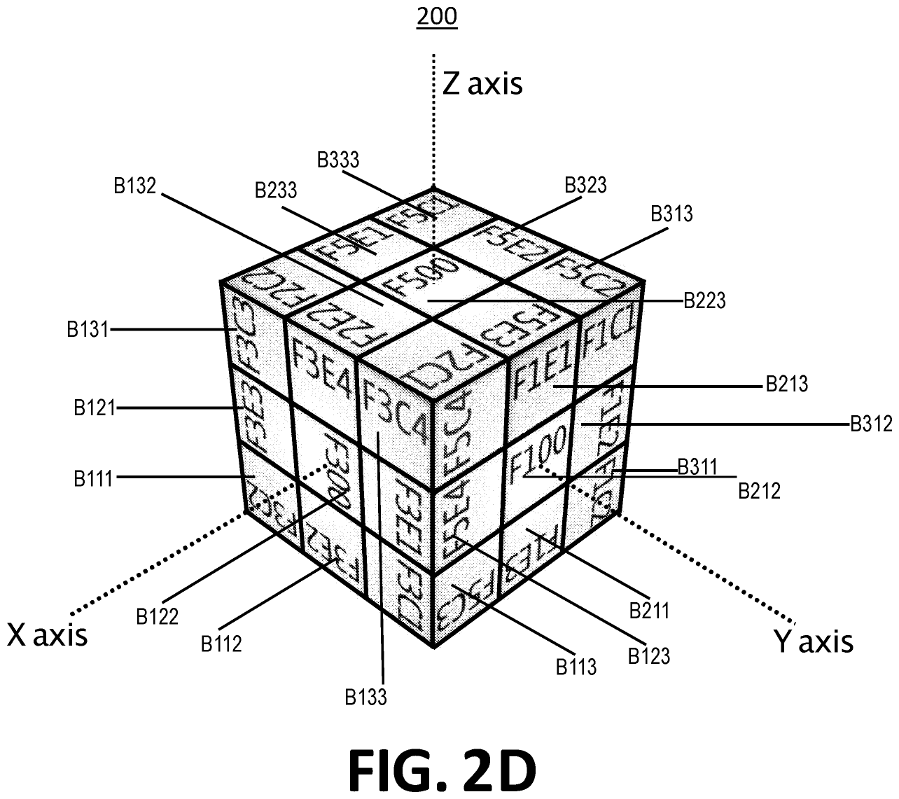

A magic cube 200 in accordance with the presently disclosed embodiment of the present invention comprises of one large cubic block 200 formed by a plurality of relatively smaller cubic blocks B111 through B333 to form a cubic body. The labeling of the smaller cubes in initial configuration of FIG. 2A is such that the first, second and third numbers after B denote the layer along X, Y and Z axes respectively.

The individual small cubes cannot be rotated individually but instead all small cubes along a layer can be moved together. There are nine (9) total layers, three (3) along each axis. As illustrated in the progression in FIG. 2A through FIG. 2D, the smaller cubes B111, B112, B113, B121, B122, B123, B131, B132 and B133, the leftmost layer along X axis can be rotated together. FIG. 2D shows the final position of each small cube, after 90° rotation along X axis as described. Layers are rotatable similar to prior art, however the faces of the smaller cubes each include printed matter and/or indicia which come up in combination with the rotatable relationships of the cubes, and give rise to novel function and result, when using the presently disclosed puzzle.

FIG. 2A through FIG. 10 are different embodiments of the invention. The key differentiating features of the invention as compared to prior art are the use of indicia, well defined orientations and ability to generate numerous meaningful combinations. Indicia are marks or indications on the visible faces of the smaller cubes including but are not limited to text, numbers, symbols, pictures. Orientation in this context is defined as the same pattern across each face of the large cube, created by the indicia in such a way that any number of rotations along any of the above mentioned layers would still yield the same orientation. The orientations of pairing logic and radial symmetry logic are described in following paragraphs however the invention includes all possible orientations which demonstrate the property defined above. A meaningful combination comprises of two or more elements represented by indicia such that a meaning is self-evident or could be derived without much effort. The definition of meaning includes but is not limited to scientific, literary, linguistic and mathematical interpretations.

FIG. 2A is an embodiment of a logic cube 200, an illustration for pairing logic. As described above, the labeling of the smaller cubes in initial configuration of FIG. 2A is such that the first, second and third numbers after B denote the layer along X, Y and Z axes respectively. Depending on the position of the smaller cubes, they are further classified into corner cubes, edge cubes and center cubes. A corner cube is a small cube with three (3) of its six (6) faces visible, such as B111, B113, B131, B133, B311, B313, B333. An edge cube is a small cube with two (2) of its six (6) faces visible, such as B112, B132, B121, B123, B213, B233, B211, B312 and B323. A center cube is a small cube with one (1) of its six (6) faces visible, such as B122, B212 and B223. The visible faces on each of the small cubes are labeled with a four-character code. The first character F stands for Face followed by a face number based on the initial configuration of cube as shown in FIG. 2A. For visible faces of edge cube, the third character is E followed by a number whereas for visible faces of corner cube the third character is C followed by number. For the visible faces of center cubes, the third and fourth characters of the label are 00. Thus, faces F1E1, F1E2, F1E3, F1E4, F3E1, F3E2, F3E3, F3E4, F5E1, F5E2, F5E3 and F5E4 are the visible faces of edge cubes. Faces F1C1, F1C2, F1C3, F1C4, F3C1, F3C2, F3C3, F3C4, F5C1, F5C2, F5C3 and F5C4 are the visible faces of corner cubes. Faces F100, F300 and F500 are visible faces of center cubes. The orientation is such that on each face of the large cube, there is one face of the center cube surrounded by four (4) pairs, with each pair comprising of a face from an edge cube and an adjacent face of a corner cube. Referring to FIG. 2A, F100 is surrounded by pairs F1E1 and F1C1, F1E2 and F1C2, F1E3 and F1C3, F1E4 and F1C4. F300 is surrounded by pairs F3E1 and F3C1, F3E2 and F3C2, F3E3 and F3C3, F3E4 and F3C4. Similarly, F500 is surrounded by pairs F5E1 and F5C1, F5E2 and F5C2, F5E3 and F5C3, F5E4 and F5C4.

As illustrated in the progression in FIG. 2A through FIG. 2D, the smaller cubes B111, B112, B113, B121, B122, B123, B131, B132 and B133, the leftmost layer along X axis can be rotated together. FIG. 2D shows the final position of each small cube, after 90° rotation along X axis as described. While the positions of some small cubes and hence their faces have changed, the previously described orientation of a face of a center cube surrounded by four (4) pairs of faces of edge and corner cube still holds true. Referring to FIG. 2D, F100 is surrounded by pairs F1E1 and F1C1, F1E2 and F1C2, F1E3 and F5C3, F5E4 and F5C4. F300 is surrounded by pairs F3E1 and F3C1, F3E2 and F3C2, F3E3 and F3C3, F3E4 and F3C4. Similarly, F500 is surrounded by pairs F5E1 and F5C1, F5E2 and F5C2, F5E3 and F2C1, F2E2 and F2C2. The two parts of the pair can be considered as two halves. In this case, the visible face of the edge cube is the left half and the adjacent visible face of the corner cube is the right half. However, another pairing can be contemplated with the visible face on the corner cube as the left half and the adjacent visible face of the edge cube as the right half. Yet, another pairing can be contemplated vertically creating top and bottom halves. This pairing provides a new function and a novel experience which can be applied to areas consisting of combinations with two elements such as algebra (two expressions), chemistry (chemical compounds with two elements or compounds), fashion (adjectives related to color, pattern or style can be the left half and piece of clothing or accessory can be the right half). The visible faces of the center cubes can be used for additional information or instruction. One such example is illustrated below.

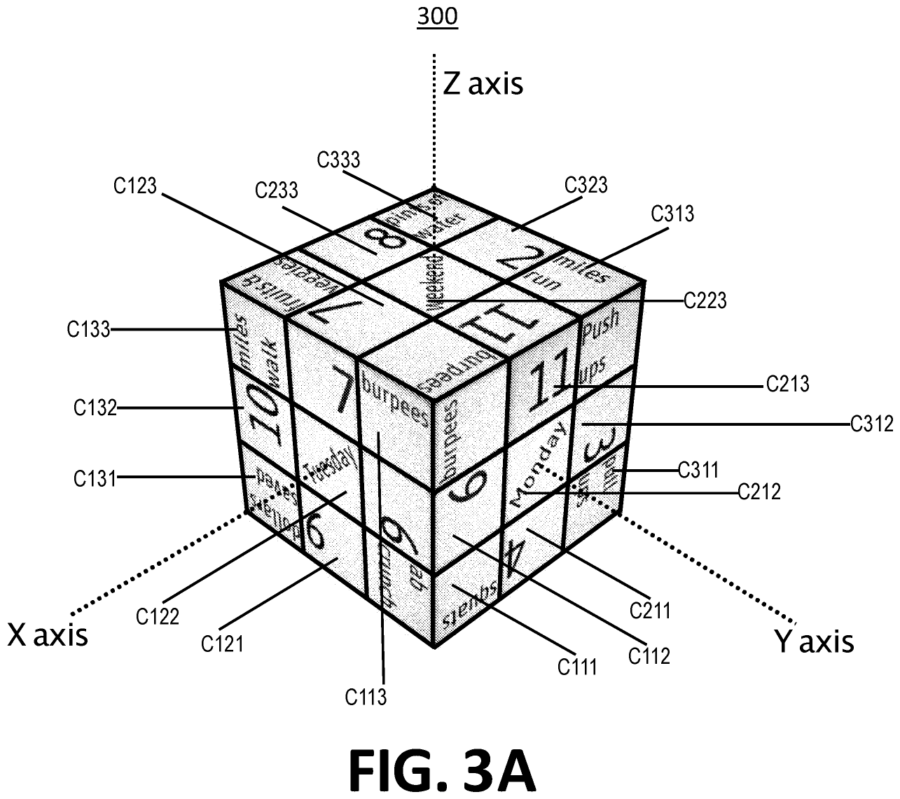

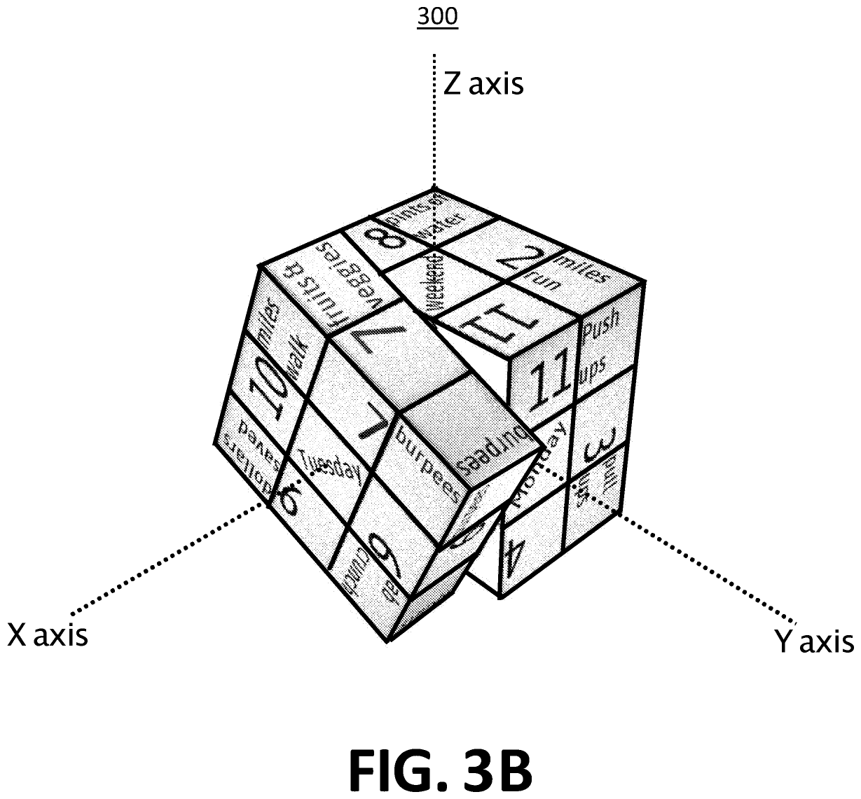

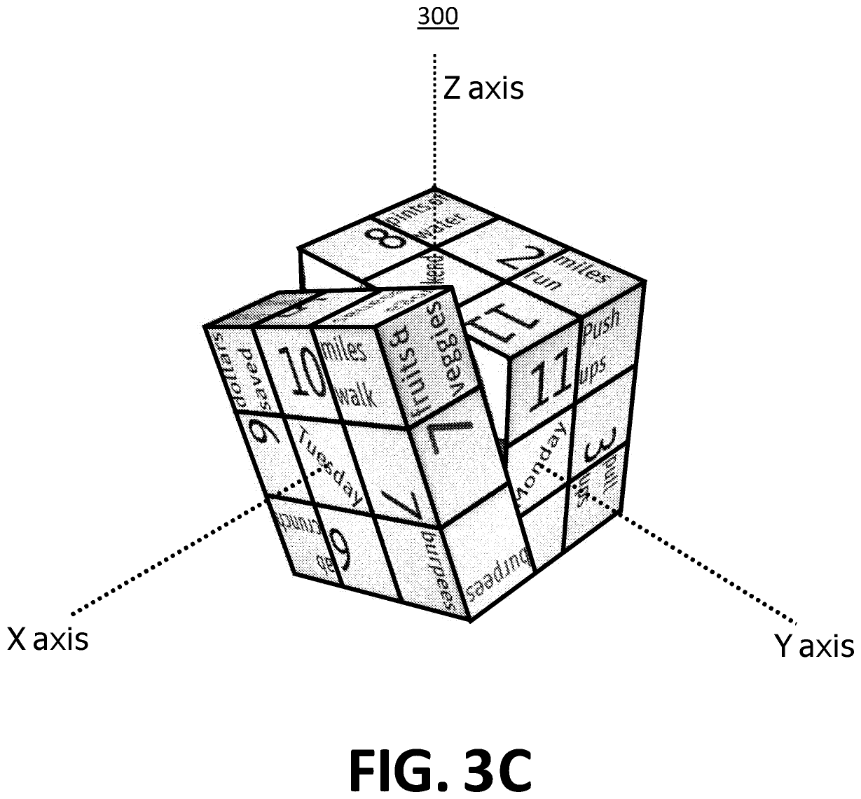

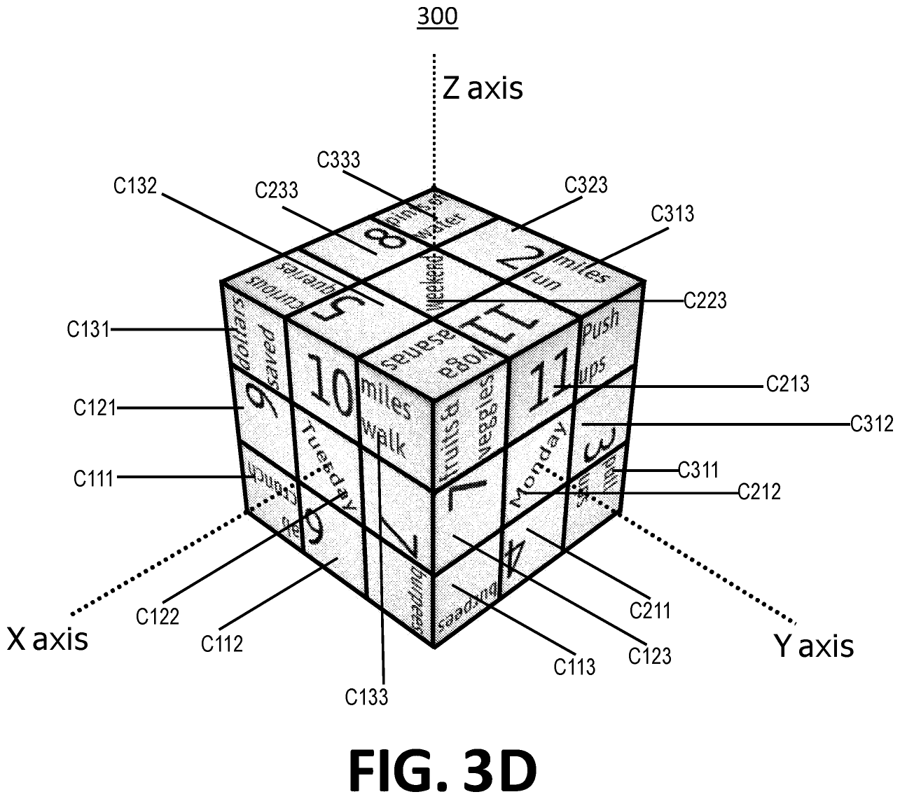

FIG. 3A is an embodiment of a logic cube 300, an exemplary for pairing logic. The labeling of the smaller cubes in initial configuration of FIG. 3A is such that the first, second and third numbers after C denote the layer along X, Y and Z axes respectively. Using the same denotation described in [21], cube 300 in FIG. 3A has numbers on the visible faces of edge cubes, actions on the visible faces of corner cubes and days of the week on the visible faces of center cubes. The idea is to perform the four actions created by the four pairs surround each visible face of the center cube. Referring to FIG. 3A, “Monday” is surrounded by actions—“11 pushups”, “3 pullups”, “4 squats” and “6 burpees”, “Tuesday” is surrounded by actions—“10 miles walk”, “6 ab crunches”, “7 burpees” and “9 dollars saved” and “weekend” is surrounded by actions—“8 pints of water”, “2 miles run”, “11 burpees” and “7 fruits and veggies”.

As illustrated in the progression in FIG. 3A through FIG. 3D, the smaller cubes C111, C112, C113, C121, C122, C123, C131, C132 and C133, the leftmost layer along X axis can be rotated together. FIG. 3D shows the final position of each small cube, after 90° rotation along X axis as described. Referring to FIG. 3D, “Monday” is surrounded by actions—“11 pushups”, “3 pullups”, “4 burpees” and “7 fruits and veggies”, “Tuesday” is surrounded by actions—“10 miles walk”, “6 ab crunches”, “7 burpees” and “9 dollars saved” and “weekend” is surrounded by actions—“8 pints of water”, “2 miles run”, “11 yoga asanas” and “5 curious queries”. A user of cube 300 would follow the combination of four activities for each day of the week as shown by each face of the large cube and then scramble the cube for every new week to generate new combinations of activities. Please note that cube 300 is for illustrative purposes only and should not be misconstrued as a recommendation for better living. However, the following paragraph can be used to create similar cubes for suitable applications.

Once the logic is understood, a design can be created for a suitable application which utilizes pairs or combination of two (2) elements. The application should be such that each left half can pair with most, if not all, rights halves and vice versa. Cube 300 has 24 visible faces of edge cubes and 24 visible faces of corner cubes. Hence applications with combination pairing of 24 left halves and 24 right halves are preferred. If there are less than 24 elements, some elements can be smartly repeated. Similarly, some combinations can be avoided. See the exclusion logic section below to provide further detail.

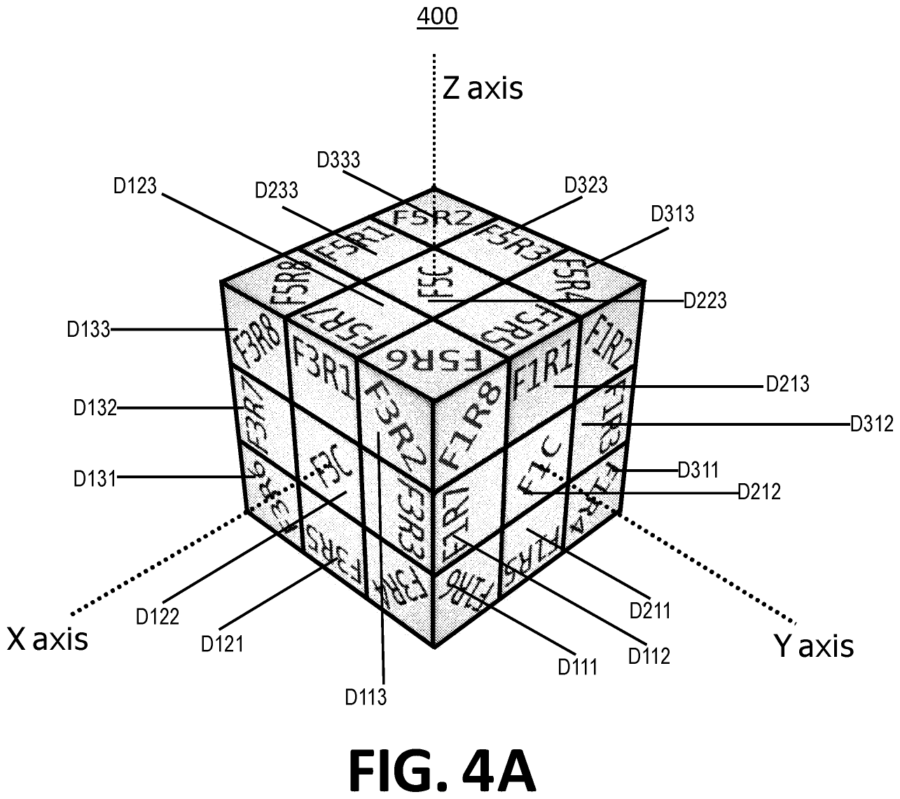

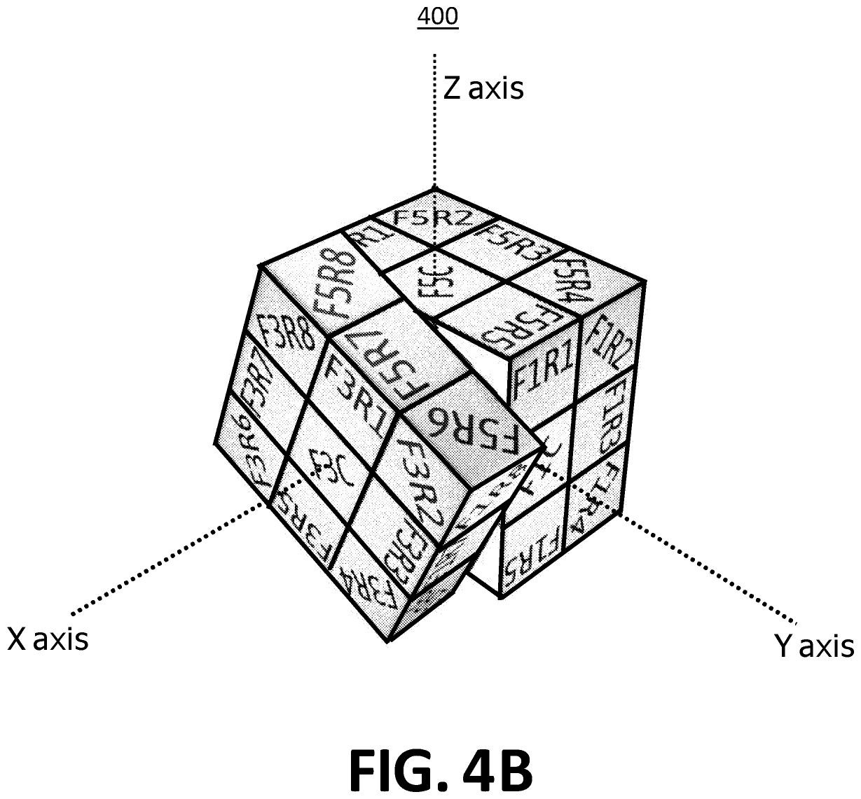

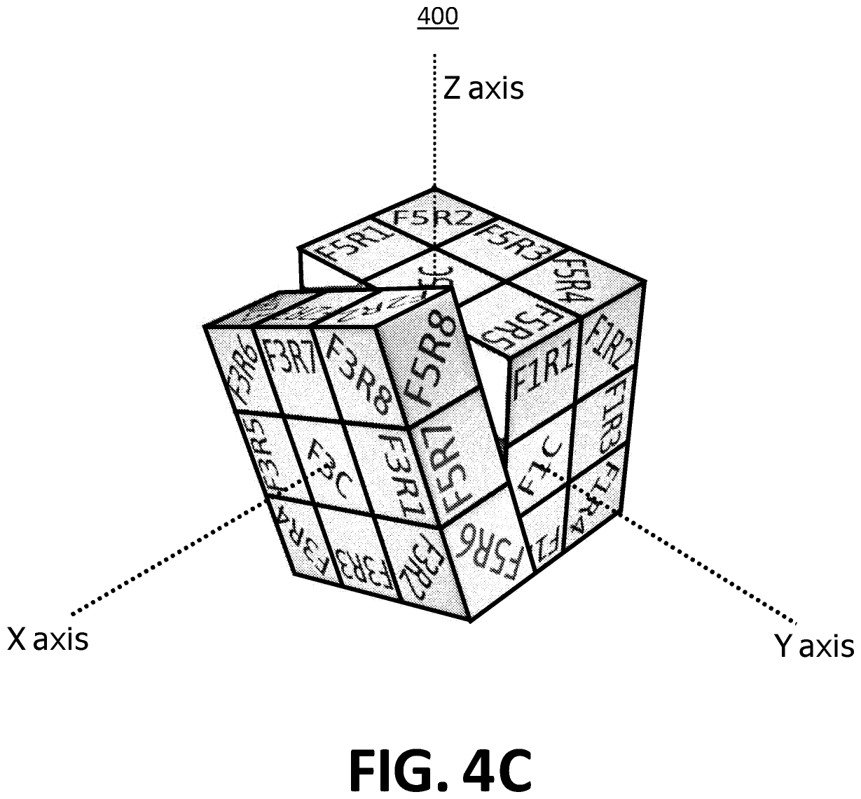

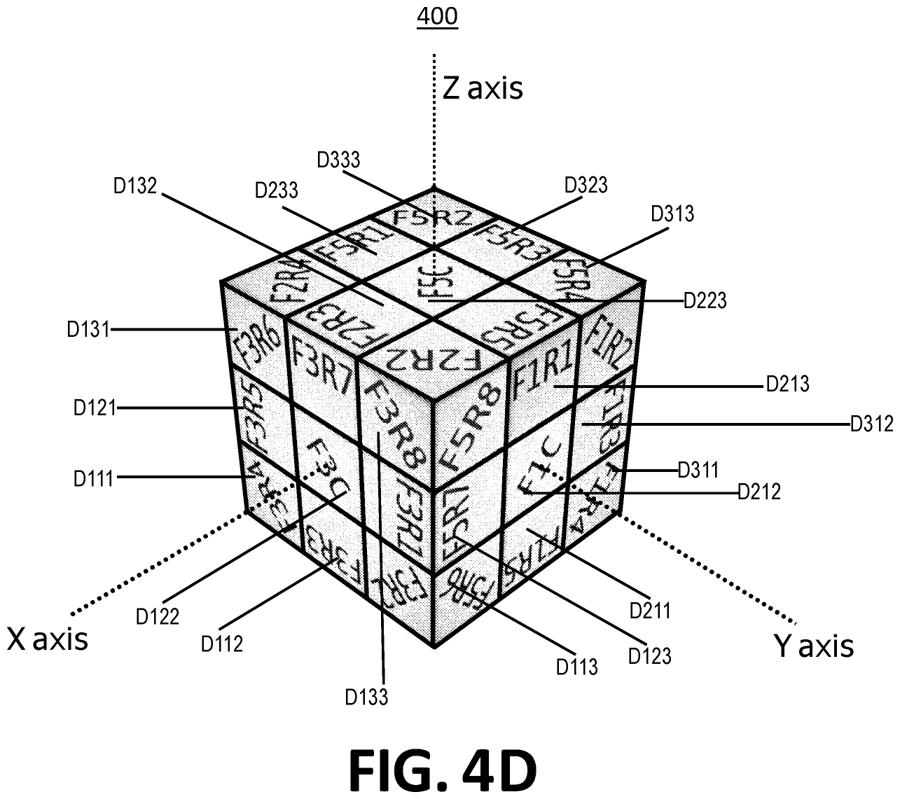

FIG. 4A is an embodiment of a logic cube 400, an illustration for radial symmetry logic. The labeling of the smaller cubes in initial configuration of FIG. 4A is such that the first, second and third numbers after D denote the layer along X, Y and Z axes respectively. The definition of edge cubes, corner cubes and center cubes are same as defined in [21]. The visible faces on each of the small cubes are labeled with a four-character code. The first character F stands for Face followed by a face number based on the initial configuration of cube as shown in FIG. 4A. For the visible faces of center cubes, the third character of the label is C for Center. For visible faces of edge and corner cube the third character is R for Radial symmetry followed by a number. The orientation is such that on each face of the large cube, there is one face of the center cube surrounded by eight (8) faces of alternating edge and corner cubes in a radial symmetry similar to a circle or an octagon. Referring to FIG. 4A, F1C is surrounded by F1R1, F1R2, F1R3, F1R4, F1R5, F1R6, F1R7 and F1R8. F3C is surrounded by F3R1, F3R2, F3R3, F3R4, F3R5, F3R6, F3R7 and F3R8. F5C is surrounded by F5R1, F5R2, F5R3, F5R4, F5R5, F5R6, F5R7 and F5R8.

As illustrated in the progression in FIG. 4A through FIG. 4D, the smaller cubes D111, D112, D113, D121, D122, D123, D131, D132 and D133, the leftmost layer along X axis can be rotated together. FIG. 4D shows the final position of each small cube, after 90° rotation along X axis as described. While the positions of some small cubes and hence their faces have changed, the previously described orientation of a face of a center cube surrounded by eight (8) faces of edge and corner cube still holds true. Referring to FIG. 4D, F1C is surrounded by F1R1, F1R2, F1R3, F1R4, F1R5, F5R6, F5R7 and F5R8. F3C is surrounded by F3R1, F3R2, F3R3, F3R4, F3R5, F3R6, F3R7 and F3R8. F5C is surrounded by F5R1, F5R2, F5R3, F5R4, F5R5, F2R2, F2R3 and F2R4. This radial symmetry logic provides a new function and novel experience which can be applied to areas consisting of combinations with eight elements such as proteins (combination of amino acids), writing (different themes, topics and styles) and music. The visible faces of the center cubes can be used for additional information or instruction. One such example is illustrated below.

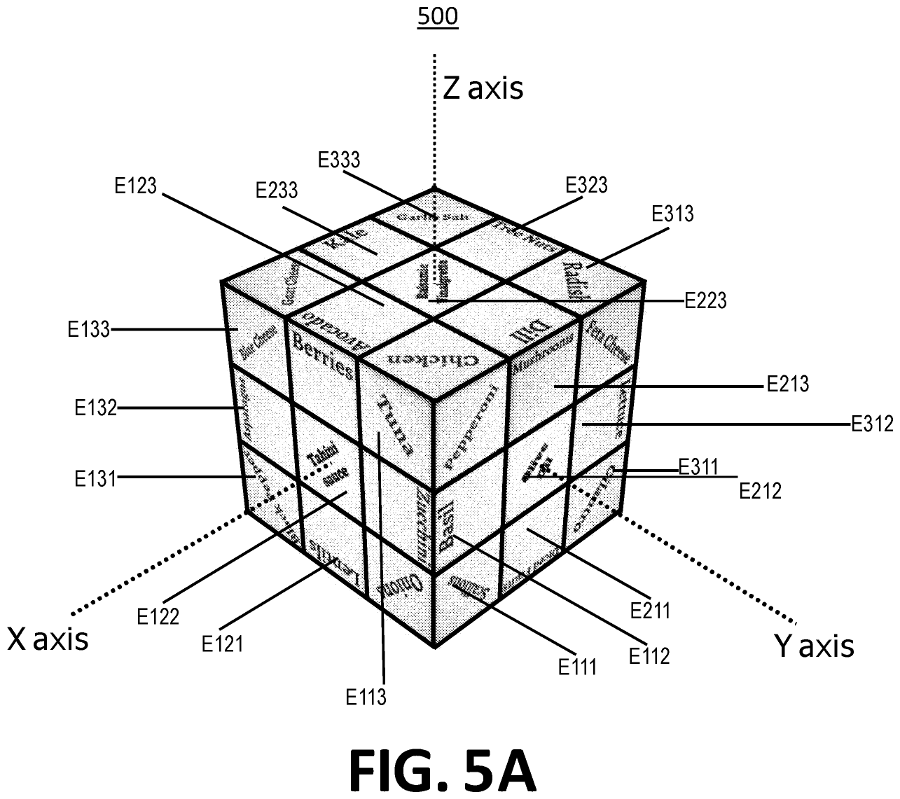

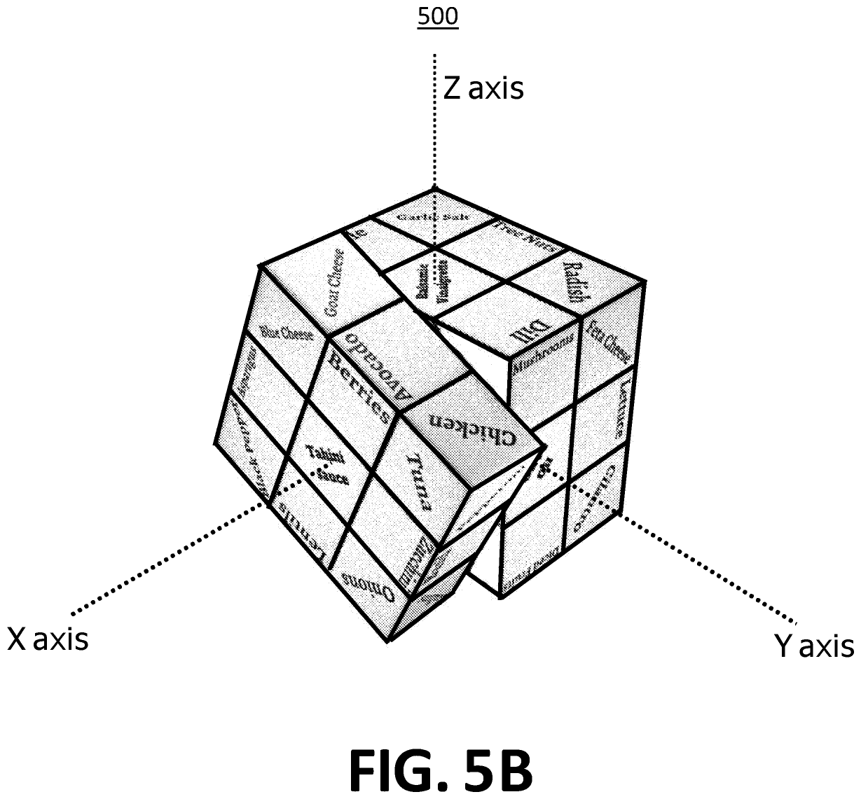

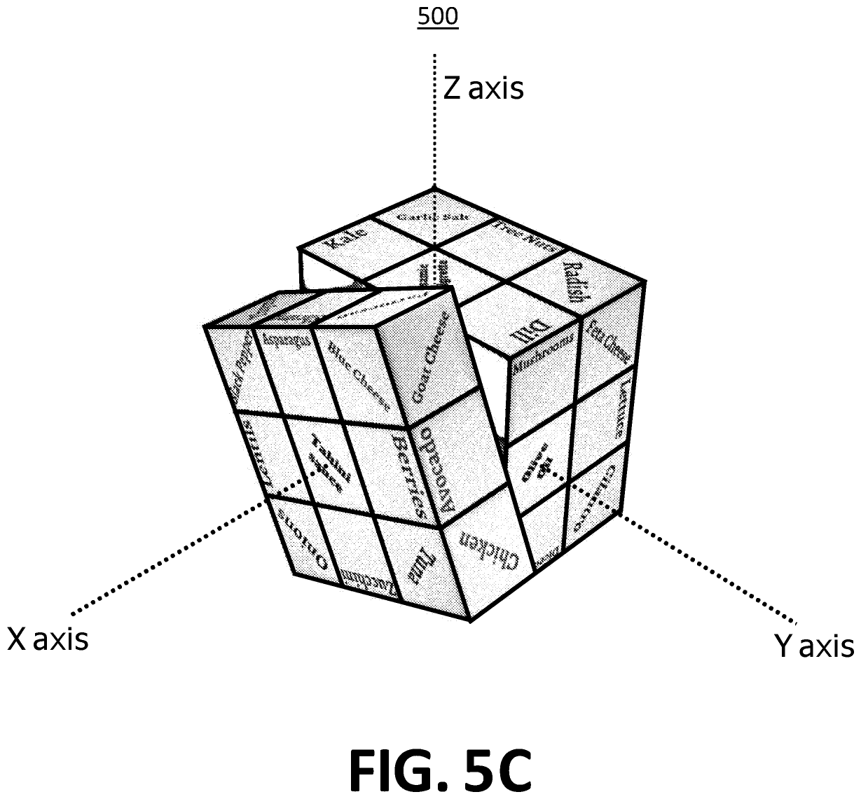

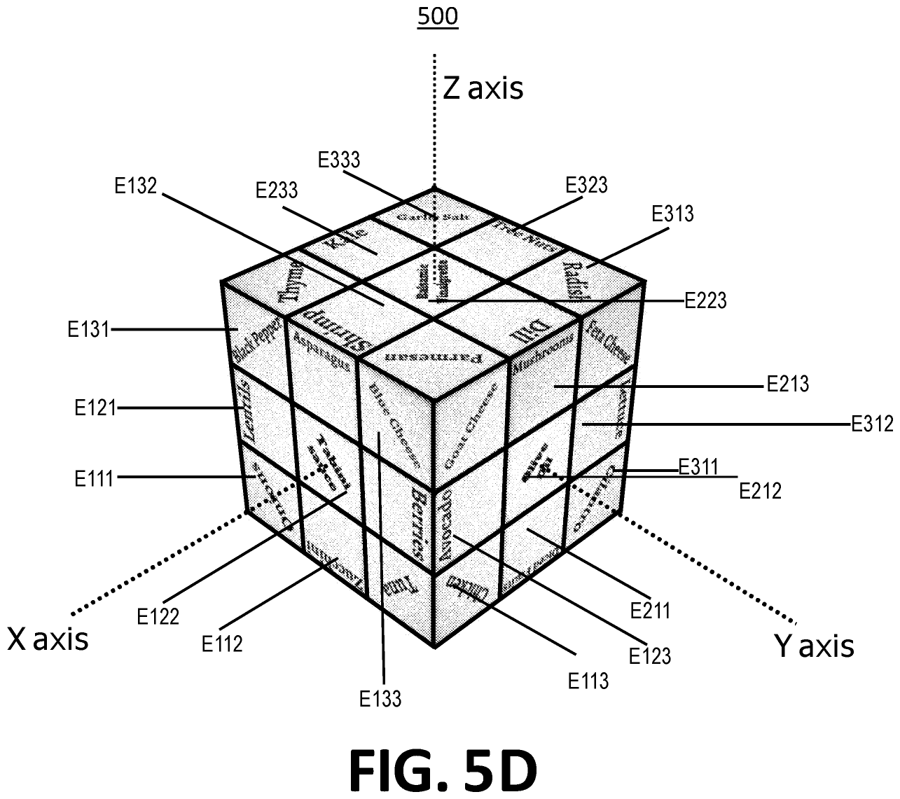

FIG. 5A is an embodiment of a logic cube 500, an exemplary for radial symmetry logic. The labeling of the smaller cubes in initial configuration of FIG. 5A is such that the first, second and third numbers after E denote the layer along X, Y and Z axes respectively. Using the same denotation described in [25], cube 500 in FIG. 5A has ingredients on the visible faces of edge and corner cubes and salad dressings on the visible faces of center cubes. The idea is create recipes or salads using those ingredients. Referring to FIG. 5A, “Olive Oil” is surrounded by—“Mushrooms”, “Feta Cheese”, “Lettuce”, “Cilantro”, “Diced Fruits”, “Scallions”, “Basil” and “Pepperoni”, “Tahini sauce” is surrounded by—“Zucchini”, “Onions”, “Lentils”, “Black Pepper”, “Asparagus”, “Blue Cheese”, “Berries” and “Tuna” and “Balsamic Vinaigrette” is surrounded by—“Kale”, “Garlic Salt”, “Tree nuts”, “Radish”, “Dill”, “Chicken”, Avocado” and “Goat Cheese”.

As illustrated in the progression in FIG. 5A through FIG. 5D, the smaller cubes E111, E112, E113, E121, E122, E123, E131, E132 and E133, the leftmost layer along X axis can be rotated together. FIG. 5D shows the final position of each small cube, after 90° rotation along X axis as described. Referring to FIG. 5D, “Olive Oil” is surrounded by—“Mushrooms”, “Feta Cheese”, “Lettuce”, “Cilantro”, “Diced Fruits”, “Chicken”, “Avocado” and “Goat Cheese”, “Tahini sauce” is surrounded by—“Zucchini”, “Onions”, “Lentils”, “Black Pepper”, “Asparagus”, “Blue Cheese”, “Berries” and “Tuna” and “Balsamic Vinaigrette” is surrounded by—“Kale”, “Garlic Salt”, “Tree nuts”, “Radish”, “Dill”, “Parmesan”, Shrimp” and “Thyme”. A user of cube 500 would use the combination of the ingredients on the face of the large cube to generate new ideas for salads or other recipes. Please note that cube 500 is for illustrative purposes only and does not take into consideration personal preferences and dietary restrictions of the user and hence it should not be misconstrued as a recommendation for making recipes. However, the following paragraph can be used to create similar cubes for suitable applications.

Once the logic is understood, a design can be created for a suitable application which utilizes combination of eight (8) elements. Cube 500 has total 48 visible faces of edge cubes and corner cubes. Hence an application with 48 elements is preferred. If there are less than 48 elements, some elements can be smartly repeated. Similarly, some combinations can be avoided. See the exclusion logic section below to provide further detail.

To add the indicia to the faces of the smaller cubes, stickers are coupled to the visible faces of the smaller cubes or the indicia is printed onto the visible faces of the smaller cubes with cautious consideration to the orientation.

Exclusion Logic.

For any orientations as defined in [23] including both the pairing logic as well as radial symmetry logic there could be certain combinations which could be meaningless or undesirable. Such combinations can be carefully avoided by using exclusion logic. Each edge cube has two visible sides and each corner cube has three visible sides which could never appear on the same face of the large cube at the same time. Similarly for a three (3) layered logic cube, visible faces of two center cubes will never appear on the same face of the large cube. With strategic placement on these squares, meaningless combinations can be successfully avoided. The same logic can be applied to repeat certain indicia such that the repetitions do not appear on the same face of the large cube at the same time.

For example; in FIG. 5A, if a user does not find the combination of “Chicken”, “Pepperoni” and “Tuna” desirable, the corner cube E113 can address that since the three visible faces will never appear on the same face of the large cube at the same time. Similarly, for repetitions, in FIG. 3A if a user wants to repeat numbers 6, 7 and 11, then edge cubes C112, C123 and C213 respectively can address that concern.

Other approaches and examples:

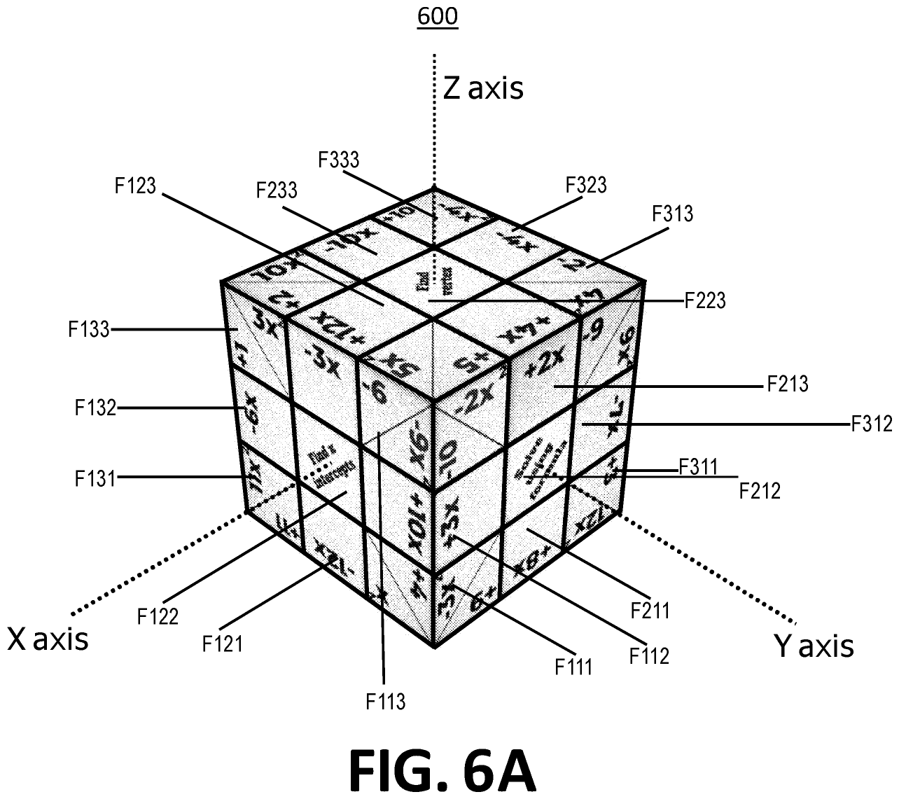

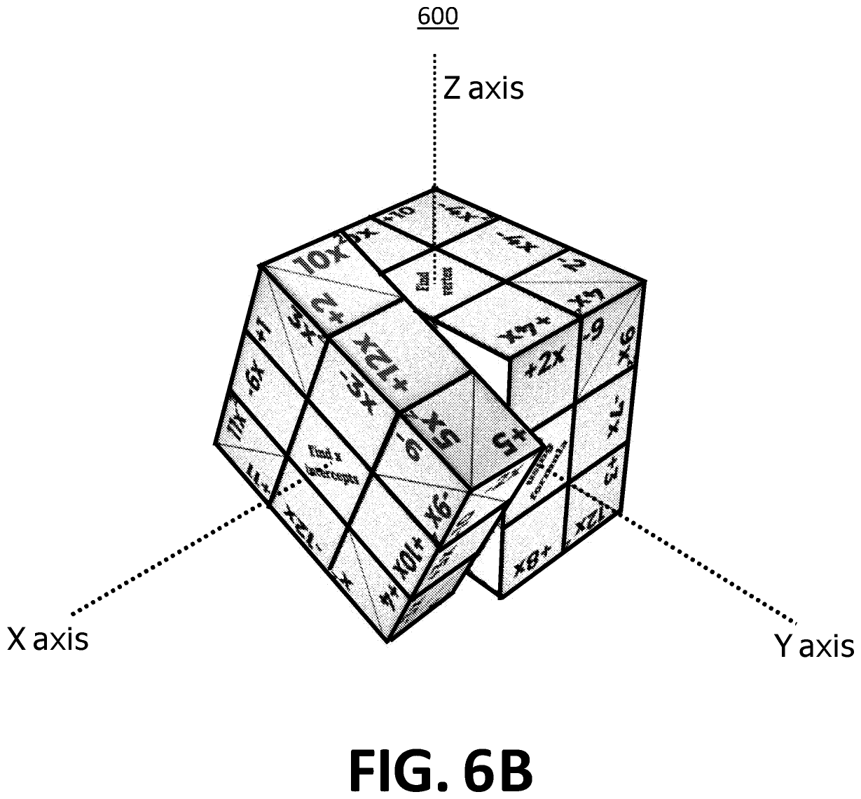

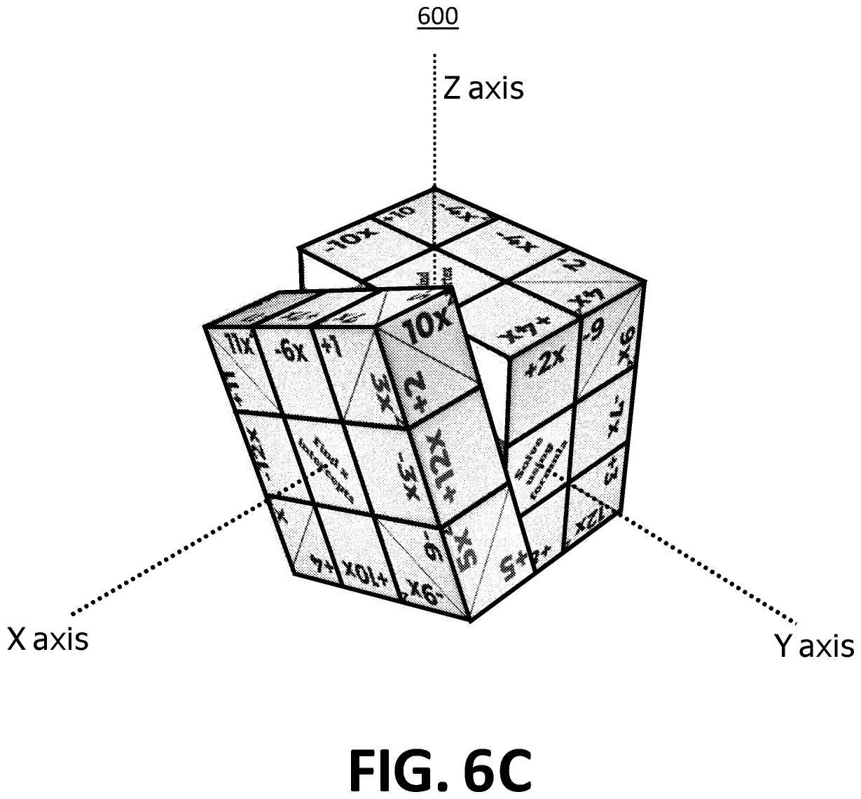

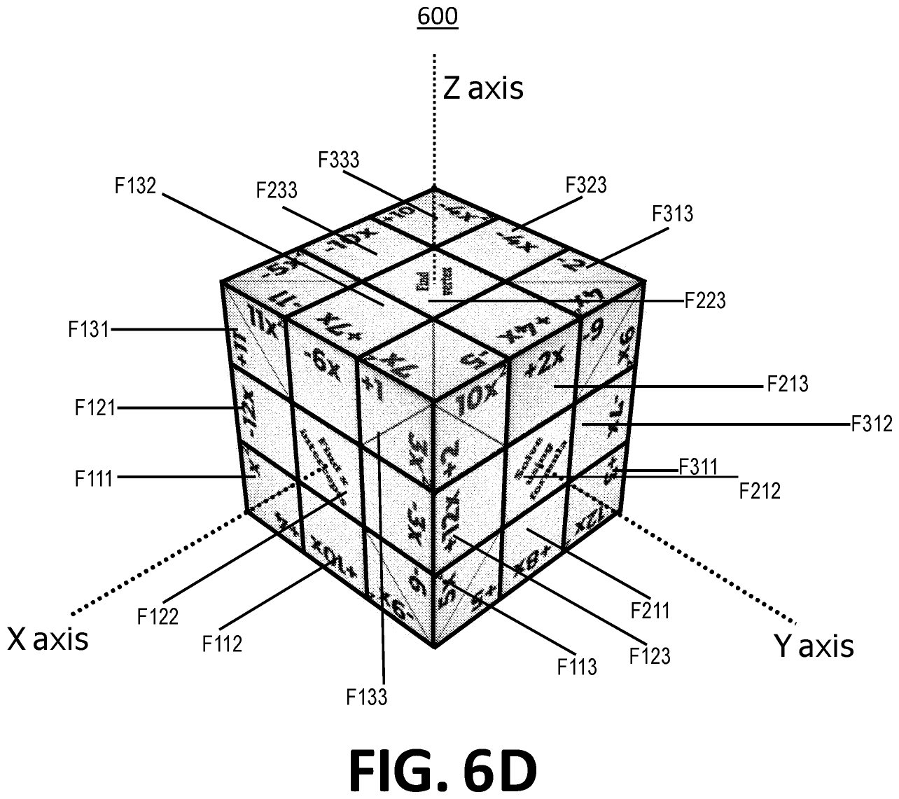

Three (3) element or Triple logic: The visible faces of corner cubes can be divided diagonally such that a combination of three (3) elements is created. Such a creation satisfies the criteria for orientation as defined in [22]. FIG. 6A is exemplary logic cube 600 using Triple logic applied to the concept of quadratic expressions in algebra. Each quadratic expression is summation of the x² term, x term and a constant. The objective of the cube 600 is to generate numerous quadratic expressions and solve them by equating them to zero. Additional instructions are provided in the visible face of the center cube. The expressions in FIG. 6A are: Surrounding “Solve using formula” are (−2x²+2x−9), (9x²−7x+3), (12x²+8x+9) and (−3x²+3x−10). Surrounding “Find x intercepts” are (3x²−3x−6), (−9x²+10x+4), (x²−12x+11) and (11x²−6x+1). Surrounding “Find vertex” are (−4x²−4x−2), (4x²+4x+5), (5x²+12x+2) and (10x²−10x+10). As illustrated in the progression in FIG. 6A through FIG. 6D, the smaller cubes F111, F112, F113, F121, F122, F123, F131, F132 and F133, the leftmost layer along X axis can be rotated together. The expressions in FIG. 6D are: Surrounding “Solve using formula” are (10x²+2x−9), (9x²−7x+3), (12x²+8x+5) and (5x²+12x+2). Surrounding “Find x intercepts” are (3x²−3x−6), (−9x²+10x+4), (x²−12x+11) and (11x²−6x+1). Surrounding “Find vertex” are (−4x²−4x−2), (4x²+4x−5), (7x²+7x−11) and (−5x²−10x+10).

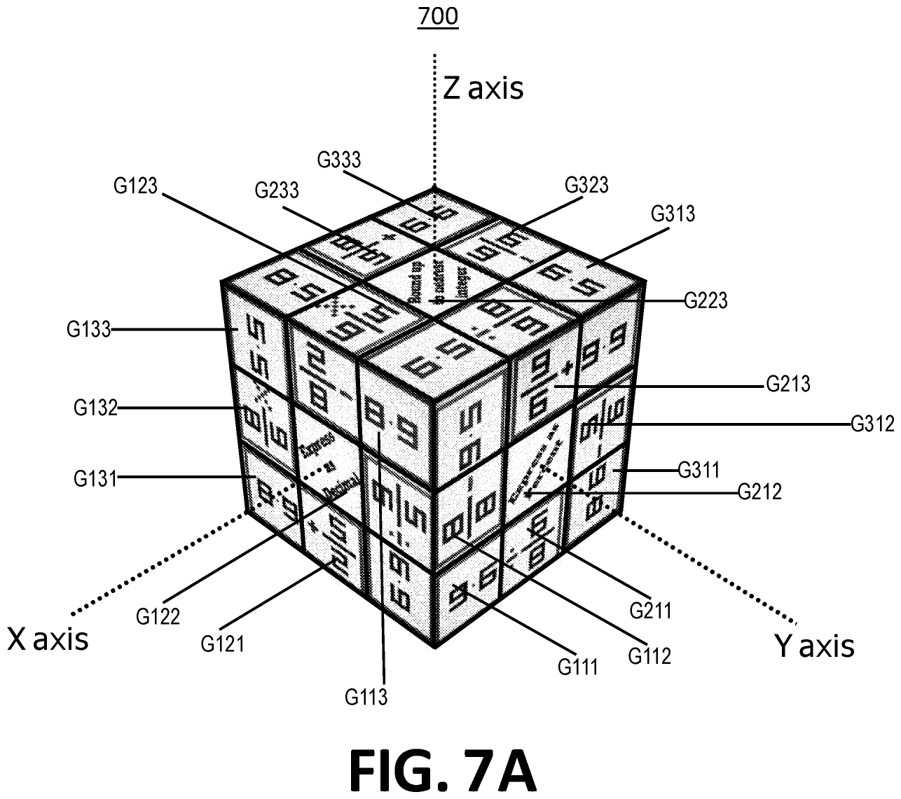

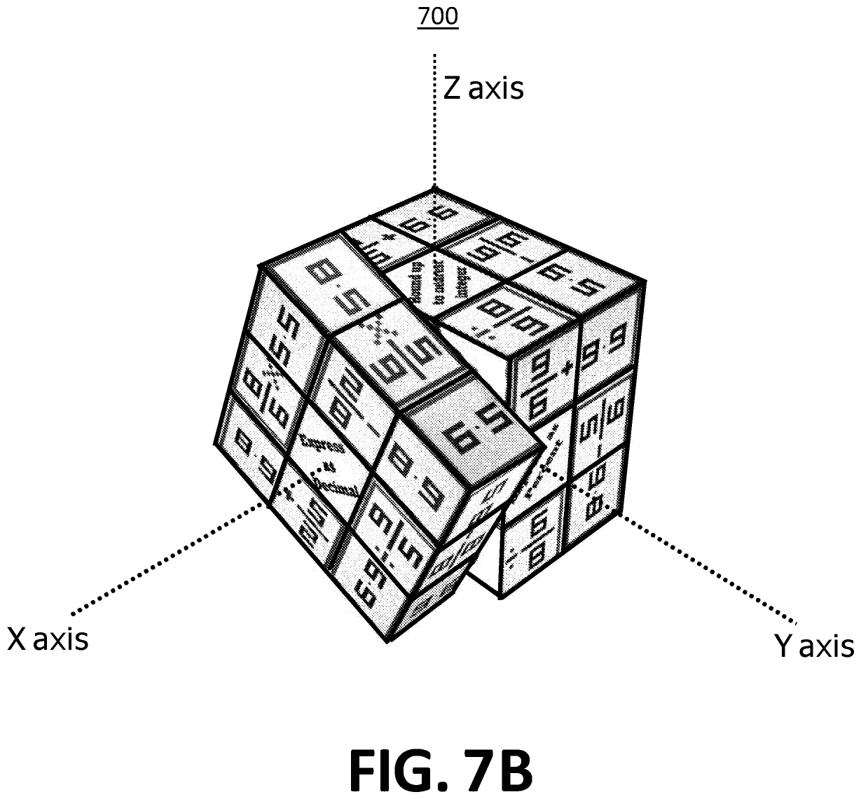

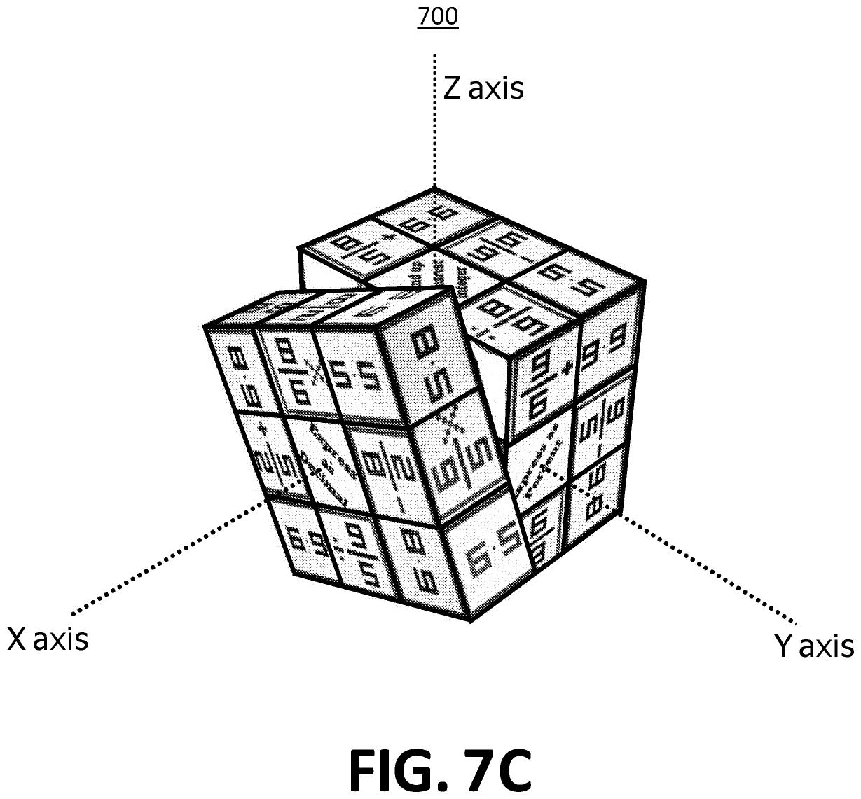

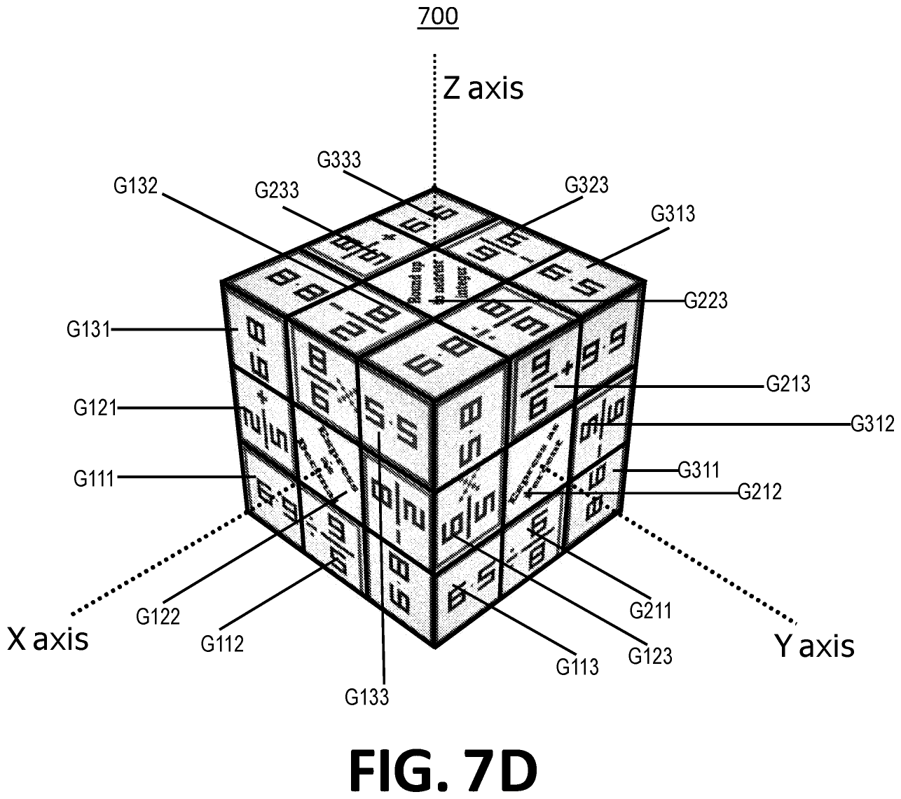

Use of Ambigrams: An ambigram is a calligraphic design that may be read as the same word, name or phrase (sometimes two different words, names or phrases) when oriented in two different ways, usually when reflected along a vertical or horizontal axis or when rotated through 180 degrees. FIG. 7A is exemplary logic cube 700 using pairing logic as well as ambigrams applied to the concept of fractions in arithmetic. Each expression is comprised of a regular fraction in p/q form and a decimal fraction, both of which can be read in two ways similar to ambigrams defined above. The objective of the cube 700 is to generate numerous questions for practice. Additional instructions are provided in the visible face of the center cube. The expressions in FIG. 7A are: Surrounding “Express as Percent” are (9/6+9.9) and (6.6+9/6) when inverted, (9/5−9.8) and (8.6−5/6) when inverted, (8/9÷9.6) and (9.6÷6/8) when inverted, (8/8−9.5) and (5.6−8/8) when inverted. Surrounding “Express as Decimal” are (2/8−8.9) and (6.8−8/2) when inverted, (5/6÷6.9) and (6.9÷9/5) when inverted, (2/5+6.8) and (8.9+5/2) when inverted, (8/6×5.5) and (5.5×9/8) when inverted. Surrounding “Round up to nearest integer” are (8/5+6.6) and (9.9+5/8) when inverted, (6/9−6.5) and (5.9−6/9) when inverted, (6/8÷5.9) and (6.5÷8/9) when inverted, (6/5×5.8) and (8.5×5/9) when inverted. As illustrated in the progression in FIG. 7A through FIG. 7D, the smaller cubes G111, G112, G113, G121, G122, G123, G131, G132 and G133, the leftmost layer along X axis can be rotated together. The expressions in FIG. 7D are: Surrounding “Express as Percent” are (9/6+9.9) and (6.6+9/6) when inverted, (9/5−9.8) and (8.6−5/6) when inverted, (8/9÷5.9) and (6.5÷6/8) when inverted, (6/5×5.8) and (8.5×5/9) when inverted. Surrounding “Express as Decimal” are (2/8−8.9) and (6.8−8/2) when inverted, (5/6÷6.9) and (6.9÷9/5) when inverted, (2/5+6.8) and (8.9+5/2) when inverted, (8/6×5.5) and (5.5×9/8) when inverted. Surrounding “Round up to nearest integer” are (8/5+6.6) and (9.9+5/8) when inverted, (6/9−6.5) and (5.9−6/9) when inverted, (6/8÷8.9) and (6.8÷8/9) when inverted, (2/8−8.8) and (8.8−8/2) when inverted.

The faces of smaller cubes can be strategically utilized to design puzzles such as:

Mazes: By having well defined patterns on the visible faces of small cubes maze/s can be created where each face of the large cube is a distinct maze or the large cube as a whole is one single maze. The patterns would be such that with any rotation along an axis would generate a new maze. In this case, indicia would be an arrangement of straight and/or curved line segments. Another embodiment of this cube can be contemplated where the indicia could be three (3) dimensional in the form of maze walls or ridges. Such a cube could create different labyrinths with every move or rotation and small ball bearing could pass through. The objective of such mazes would be to chart a continuous path from a predefined starting point on the large cube to a predefined ending point. This can be extrapolated to money maze puzzle box.

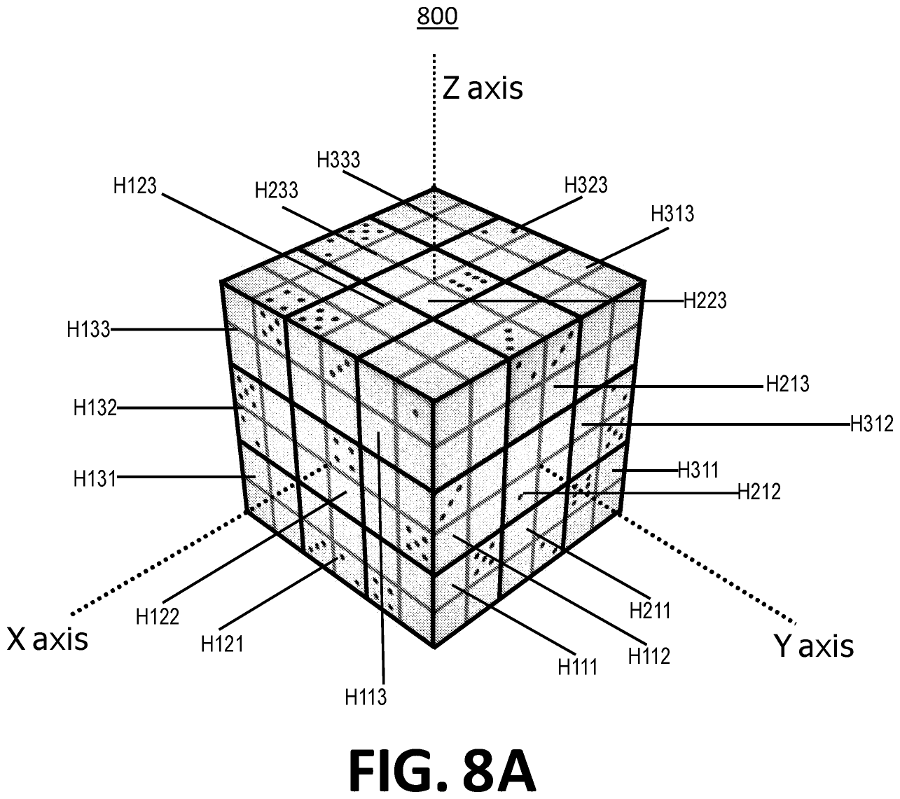

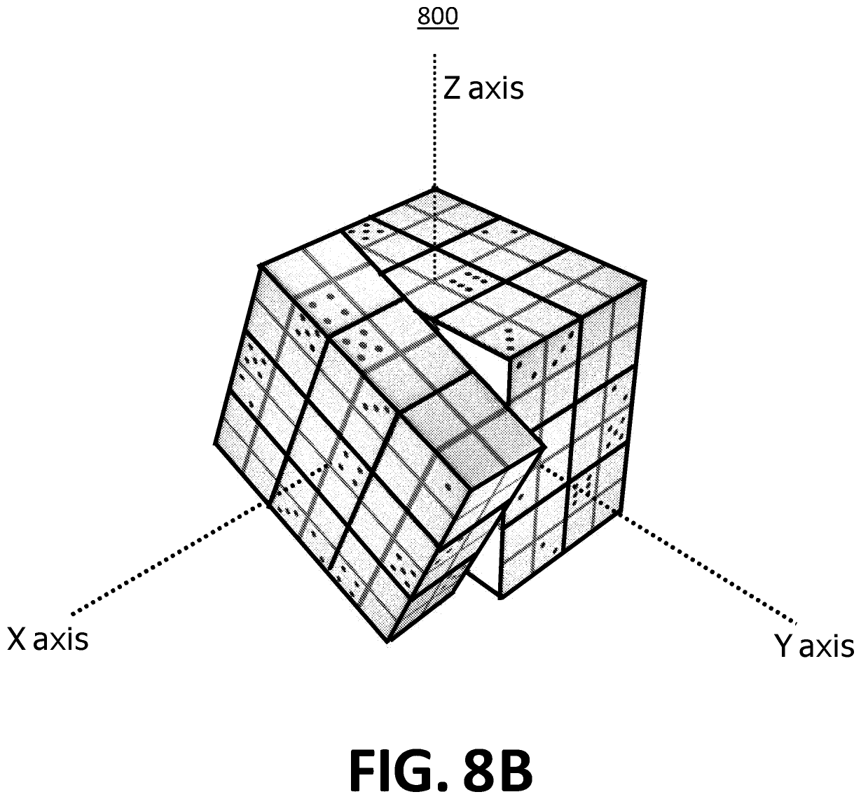

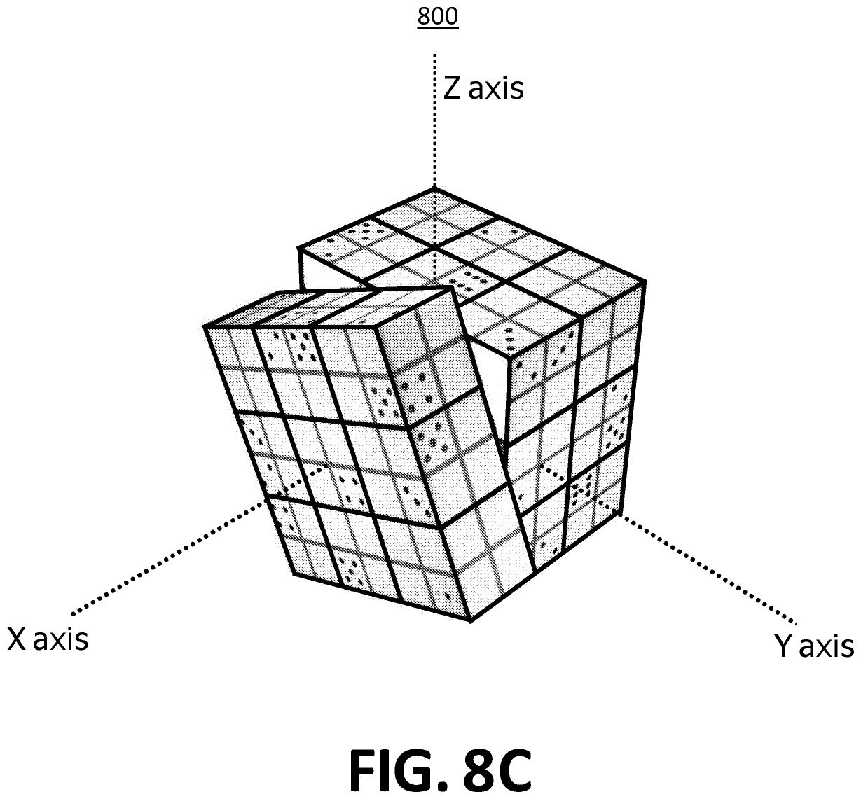

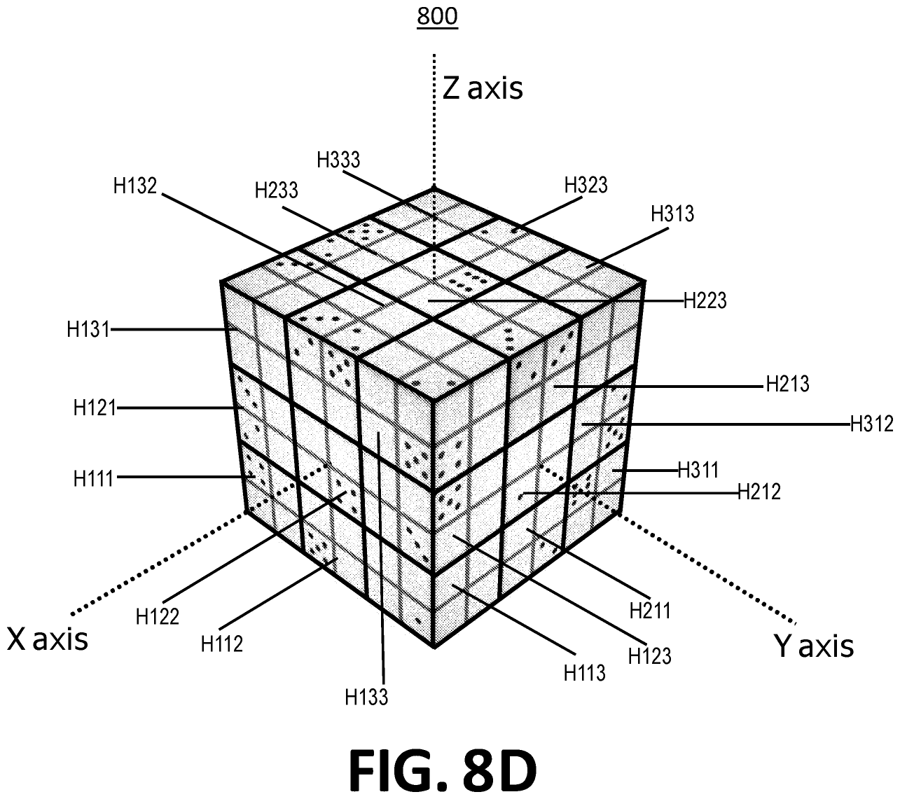

Puzzles similar to Sudoku: A Sudoku is a partially filled square grid with the objective of filling the blank spaces in such a way that each row and each column has a number, character or element appearing only once. A Sudoku could have additional constraints depending on the size of the grid. FIG. 8A is an embodiment where each visible face of every small cube is further divided into 2×2 grid and partially filled with numbers. The numbers are denoted as faces of a standard die for orientation purposes. Thus, each face of the large cube is a 6×6 grid and the objective is to fill the blank squares of the grid such that each number from 1 through 6 appears in each column and each row only once. As illustrated in the progression in FIG. 8A through FIG. 8D, every rotation can create a new puzzle.

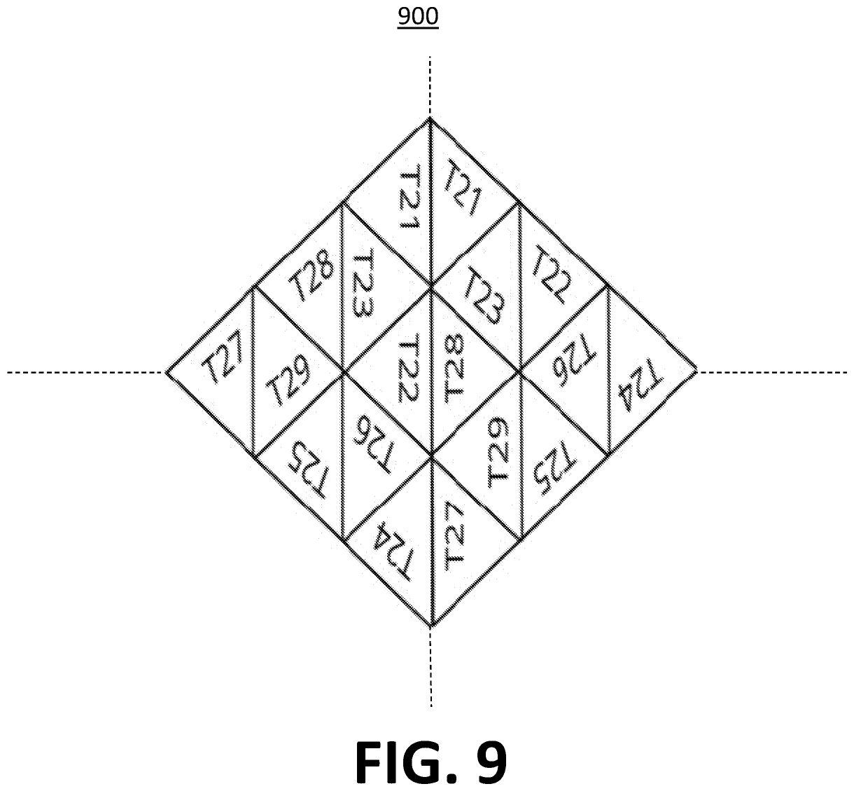

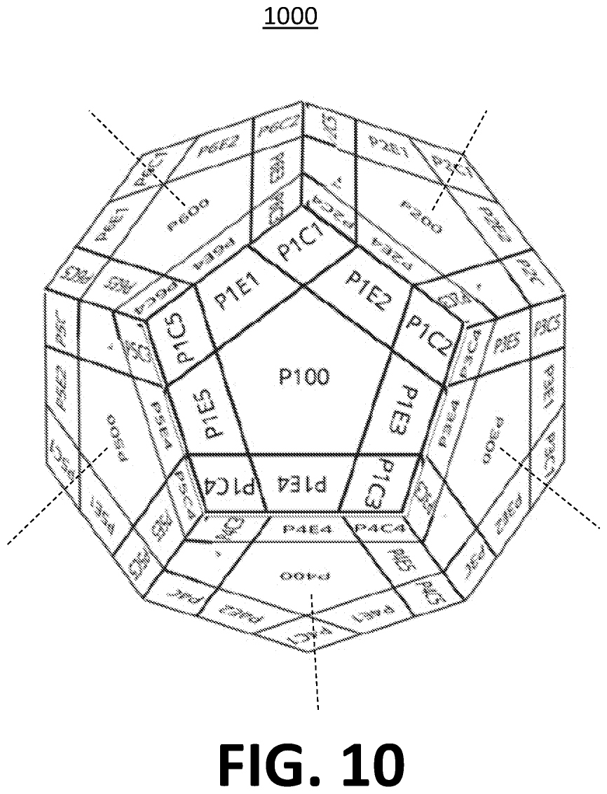

Other shapes: The invention can be applied to other geometric solids such as tetrahedron with triple logic as shown in FIG. 9 and dodecahedron with pairing as shown in FIG. 10, where orientations as mentioned above can be applied to create meaningful combinations.

Artistic rendering:

The above-mentioned approaches are strictly from an illustrative perspective. The logic cubes 200, 300, 400, 500, 600, 700 and 800, logic tetrahedron 900 and logic dodecahedron 1000 can be improved aesthetically with use of proper artistic rendering such as pictures or patterns. Aesthetics of indicia may vary for different applications.

Although the invention has been explained in relation to its presently disclosed embodiments) as mentioned above, it is to be understood that many other possible modifications and variations can be made without departing from the scope of the present invention. It is, therefore, contemplated that the appended claim or claims will cover such modifications and variations that fall within the true scope of the invention.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-20. (canceled)

21. A logic cube for generating meaningful combinations comprising:
a first cubic solid having three large axes and six large faces, the first cubic solid further comprising:
a plurality of small cubic solids, the plurality of small cubic solids each having three axes parallel to the three large axes and at least one visible face coplanar with one of the large faces of the first cubic solid and the remaining faces internal to the first cubic solid, said plurality of small cubic solids further comprising a plurality of center cubic solids having one visible face coplanar with one of the large faces, a plurality of edge cubic solids having two visible faces coplanar with two of the large faces, and a plurality of corner cubic solids having three visible faces coplanar with three of the large faces; and
the small cubic solids retained within the first large cubic solid in rotatable layers, wherein layers are rotatable around one of the three large axes, and a small cubic solid may be rotated with a plurality of layers; and
wherein visible faces of the small cubic solids comprise pairs of indicia disposed thereon the pairs of indicia comprising a first half on a visible face of an edge cubic solid and the second half on a visible face of a corner cubic solid such that the pairs of indicia provide at least one meaningful expression for at least one rotatable orientation of the small cubic solids within the first cubic solid
wherein all visible faces on the edge cubic solids comprise the first half of a meaningful expression and all visible faces on the corner cubic solids comprise the second half of a meaningful expression, and
wherein all orientations of the edge and corner cubic solids comprise a meaningful expression regardless of a rotation of layers.

22. The logic cube of claim 21, wherein pairs of indicia further comprise a first half on a visible face of a corner cubic solid and the second half on a visible face of an edge cubic solid.

23. The logic cube of claim 21, wherein each large face comprises four meaningful expressions for every rotatable orientation of the small cubic solids within the first cubic solid.

24. (canceled)

25. (canceled)

26. The logic cube of claim 21, wherein the second half of the pairs of indicia are positioned on the visible faces of a given corner cubic solid with different orientations relative to a visible corner of the given corner cubic solid such that it forms a meaningful expression with any visible face of an adjacent edge cubic solid.

27. The logic cube of claim 21, wherein the indicia comprise text in one or more languages.

28. The logic cube of claim 21, wherein the indicia comprise numbers in one or more arithmetic formats.

29. The logic cube of claim 21, wherein the indicia comprise pictures or symbols.

30. The logic cube of claim 21, wherein the indicia comprise three (3) dimensional indicia.

31. The logic cube of claim 21, wherein the indicia comprise ambigrams interpretable in two or more ways.

32. The logic cube of claim 21, wherein the number of rotatable layers of the first large solid along each axis is greater than three (3).

33. The logic cube of claim 32, further comprising four rotatable layers wherein each rotatable layer comprises 16 small cubic solids, and the plurality of indicia further comprise a third element such that the indicia comprise at least one meaningful expression on one corner cubic solid and two adjacent edge cubic solids for at least one rotatable orientation of the small cubic solids within the first cubic solid.

34. The logic cube of claim 21, wherein the indicia on both visible faces of each edge cubic solid are identical and rotated 180 degrees from each other on an external edge of the edge cubic solid, and wherein the indicia on the three visible faces of each corner cubic solid are identical and rotated 120 degrees from each other around an external corner of the corner cubic solid.

35. The logic cube of claim 21, wherein the indicia being stickers.

36. The logic cube of claim 21, wherein the indicia being printed.

37. A logic cube for generating meaningful combinations comprising:
a first cubic solid having three large axes and six large faces, the first cubic solid further comprising:
a plurality of small cubic solids, the plurality of small cubic solids each having three axes parallel to the three large axes and at least one visible face coplanar with one of the large faces of the first cubic solid and the remaining faces internal to the first cubic solid, said plurality of small cubic solids further comprising a plurality of center cubic solids having one visible face coplanar with one of the large faces, a plurality of edge cubic solids having two visible faces coplanar with two of the large faces, and a plurality of corner cubic solids having three visible faces coplanar with three of the large faces; and
the small cubic solids retained within the first large cubic solid in rotatable layers, wherein layers are rotatable around one of the three large axes, and a small cubic solid may be rotated with a plurality of layers; and
wherein each visible face of a corner cubic solid comprises two internal edges adjacent to an edge cubic solid and two external edges, and further comprises two indicia each parallel to an external edge; and
wherein visible faces of the small cubic solids comprise combinations of three elements of indicia disposed thereon, the combinations of indicia comprising a first and a third element on visible faces of corner cubic solids and a second element on a visible face of an edge cubic solid between the corner cubic solids such that the combinations of indicia provide at least one meaningful expression for at least one rotatable orientation of the small cubic solids within the first cubic solid, and
wherein all orientations of the edge and corner cubic solids comprise a meaningful expression regardless of a rotation of layers.

38. The logic cube of claim 37, wherein each large face comprises four meaningful expressions for every rotatable orientation of the small cubic solids within the first cubic solid.
